(19) United States
(12) Patent Application Publication
(10) Pub. No.: US 2008/0128381 A1
(43) Pub. Date: Jun. 5, 2008

(54) Pill bottle with indicator device

(76) Inventor: Nicholas H. Ramoundos, New York, NY (US)

Correspondence Address: GREENBERG TRAURIG, LLP, 200 PARK AVE., P.O. BOX 677, FLORHAM PARK, NJ, 07932, US

(21) Appl. No.: 11/606,473

(22) Filed: Nov. 30, 2006

(51) Int. Cl. G09F 9/40

(52) U.S. Cl. 215/230; 116/308

(57) ABSTRACT

A pill bottle having a container and a closure removably fastened to the container. The closure includes a dial rotatably housed therein, which has a first surface having a series of indicia and a second surface having a handle that protrudes outwardly therefrom. Each indicia represents a time period, such as a day and/or a time of day, at which time a next pill dosage is required to be taken by the user. The outer surface of the closure includes a window that is sized and shaped to expose a particular indicator. Upon removing the closure from the container, the user can rotate the dial via the handle in order to expose in the window the next day and/or time of day a dose is required to be consumed. The dial can only be rotated after the closure is removed from the pill container. Upon replacing the closure onto the container, the selected indicator remains immovable and represents an accurate reminder for the next time a dose is required to be taken.

### FIELD OF THE INVENTION

The present invention relates to closures for pill bottles, and more particularly, to closures for pill bottles that include indicator devices for keeping track of medication schedules.

### BACKGROUND OF THE INVENTION

There exists a number of pill bottle closures having indicators, such as dials, that enable a user to keep track of his medication schedule (e.g., the day and/or time of day when the user must take his next medication dosage). Some of these closures employ mechanisms, such as ratcheting teeth, that automatically rotate the dials upon the removal of the closures from the containers, or upon replacement of the closures onto the containers, so as to display new indications of the next dosage period. Other closures employ dials that are manually rotated by a user.

The problem with these existing closures is that the dials may be inadvertently rotated, which would result in false indications of the next time period a user must take his medication. For instance, if a user removes the closure from, or fastens the closure to, the bottle without intending to rotate the indicator dial, then the dial would display an inaccurate reading. Likewise, manually moveable indicator dials can be inadvertently rotated, regardless of whether the cap is affixed to, or unfastened from, the bottle (for instance, when the bottle is in a user's pocket, luggage, etc). Therefore, what is needed, but has yet to be provided, is a pill bottle closure that employs an indicator dial which, once the indication of the dial is properly set and the closure attached to the bottle, is not subject to inadvertent rotation.

### SUMMARY OF THE INVENTION

The problems and disadvantages associated with the prior art are overcome by the present invention, which includes a pill bottle having a container and a closure that is removably fastened to the container. The closure includes a dial that is rotatably housed therein. The dial includes an upper surface having a series of indicia imprinted thereon (e.g., days of the week, times, etc.) and a lower surface having a handle that protrudes outwardly therefrom. Each indicator represents a time period, such as a day and/or a time of day, at which time a next pill dosage is required to be taken by the user. The outer surface of the closure includes a window that is sized and shaped to expose a particular indicator.

Upon removing the closure from the container, the user can rotate the dial via the handle in order to expose in the window the next day and/or time of day a dose is required to be consumed. The dial can only be rotated after the closure is removed from the pill container. Upon replacing the closure onto the container, the selected indicator (which is visible through the window) remains immovable and represents an accurate reminder for the next time a dose is required to be taken.

Specifically, the present invention has been adapted for use in connection with pill bottles. However, the present invention can be adapted for use in connection with other types of bottles or dispensers, such as liquid medication bottles, vitamin bottles, and other food and beverage containers.

### BRIEF DESCRIPTION OF THE DRAWINGS

For a better understanding of the present invention, reference is made to the following detailed description of an exemplary embodiment considered in conjunction with the accompanying drawings, in which:

FIG. 1 is a perspective view of a pill bottle constructed in accordance with an exemplary embodiment of the present invention;

FIG. 2 is an exploded perspective view of the pill bottle shown in FIG. 1;

FIG. 3 is a top elevational view of the pill bottle shown in FIG. 1;

FIG. 4 is a top elevational view of a dial employed by the pill bottle shown in FIG. 3;

FIG. 5 is a cross sectional view, taken along section line 5-5 and looking in the direction of the arrows, of the pill bottle shown in FIG. 3.

### DETAILED DESCRIPTION OF THE INVENTION

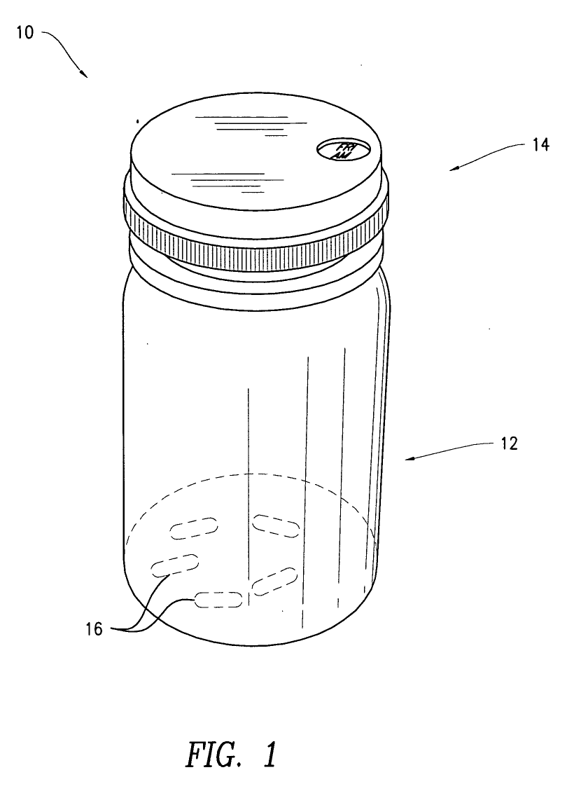

Referring to FIG. 1, a pill bottle 10 includes a cylindrical-shaped container 12 and a disc-shaped closure 14 that is sized and shaped to be removably attached to the container 12. The container 12 is adapted to receive a plurality of pills 16, such as capsules or tablets. However, the container 12 may be adapted to receive other forms of medication, such as liquid medication, or it can be adapted to receive other items, such as vitamins or food and beverage products.

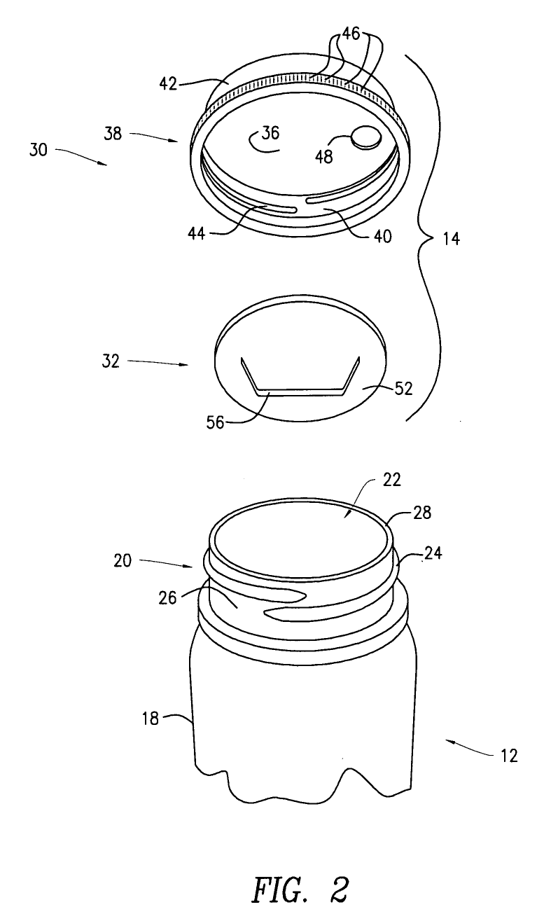

Referring to FIG. 2, the container 12 includes a cylindrical-shaped body 18 having a neck 20 formed at an upper end 21 thereof. The neck 20 includes a circular-shaped opening 22 through which the pills 16 are placed into and removed from the container 12. The neck 20 further includes a plurality of threads 24 formed on an exterior surface 26 thereof and a flat, circular-shaped edge 28 that circumferentially surrounds the opening 22.

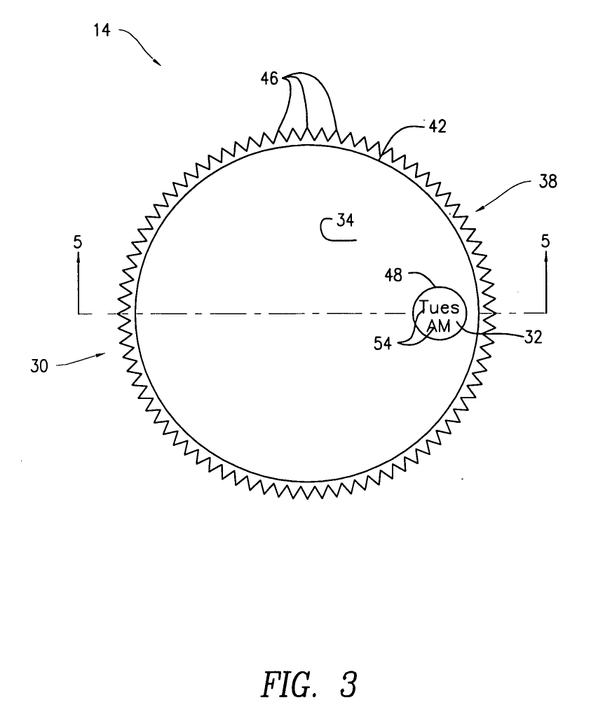

Referring now to FIGS. 2 and 3, the closure 14 includes a cap 30 and a disc-shaped dial 32 that is housed rotatably within the closure 14 in a manner which will be described in greater detail hereinafter. The cap 30 includes an upper surface 34 and a lower surface 36, and a cylindrical-shaped skirt 38 having an interior surface 40 with a diameter D1 and an exterior surface 42. A plurality of threads 44 are disposed on the interior surface 40 of the skirt 38, and are sized and shaped to threadedly engage the threads 24 of the container 12 so that the closure 14 may be removably affixed thereto. The exterior surface 42 of the skirt 38 includes knurling 46, whose function shall be described hereinafter.

Still referring to FIGS. 2 and 3, the cap 30 further includes a circular-shaped window 48 that extends from the upper surface 34 to the lower surface 36 thereof. Preferably, the cap 30 includes the window 48, but it may include more than one window. The function of the window 48 shall be described hereinafter.

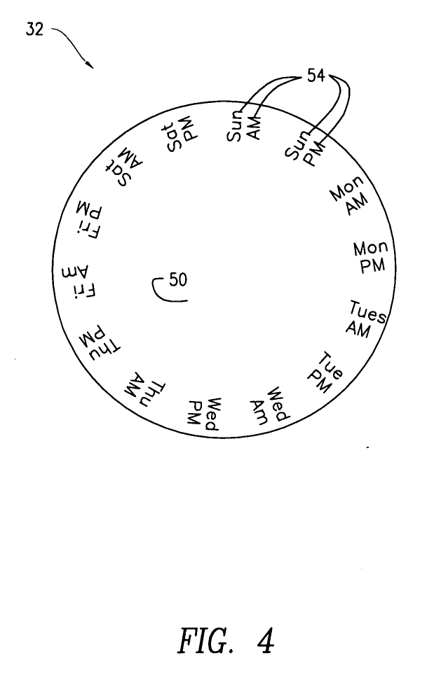

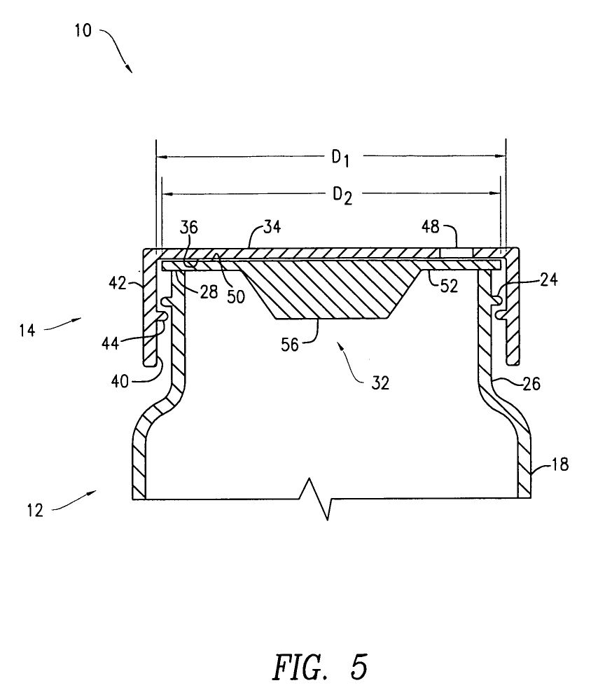

Referring now to FIGS. 4 and 5, the dial 32 includes an upper surface 50 and a lower surface 52, and has a diameter D2 (not shown in FIG. 4, but see FIG. 5). The upper surface 50 of the dial 32 includes indicia 54, while a handle 56 protrudes outwardly from the lower surface 52 of the dial 32 (not shown in FIG. 4, but see FIG. 5). The diameter D1 of the skirt 38 is only slightly larger than the diameter D2 of the dial 32; and, therefore, the dial 32 is free to rotate. In addition, the threads 40 outwardly extend far enough in order to prevent the dial 32 from disengaging from the cap 30.

Many types of indicia 54 may be utilized. These include, but are not limited to, time of day (e.g., 8:00 AM, 4:00 PM, etc.); day of the week (e.g., Sunday, Monday, etc.); and number of pills (e.g., 1 pill, 2 pills).

Preferably, the container 12 and the cap 30 are fabricated from plastic (e.g., by injection molding), but they may be made with other materials known in the art. The container 12 may be clear or opaque. The dial 32 is also, preferably, fabricated from plastic, but it can be made from other materials.

Preferably, the body 18 of the container 12 is cylindrical in shape, but it may consist of other shapes and sizes. Preferably, the window 48 is circular in shape, but it may consist of other shapes and sizes, (e.g., square, rectangular, elliptical, triangular, etc.).

Use of the pill bottle 10 is accomplished in the following manner. Aided by the knurling 46, a user twists off the closure 14 from the container 12 for access to the pills 16. The user may then set the dial 32 to indicate the next time he must take his next dosage of medication. More particularly, the dial 32 is rotated by grasping the handle 56 in order to expose in the window 48 the desired indicia 54 (e.g., the next day and/or time of day) when a next dose is required to be consumed. The closure 14 is then placed back onto the neck 20 of the container 12 such that the closure 14 is threadedly engaged with the container 12. In this position, the dial 32 is wedged between the edge 28 of the container and the lower surface 36 of the cap 30. As a result, the dial 32 is prohibited from rotating relative to the cap 30; and, therefore, the correct indicia 54 will be viewed through the window 48. In addition, the handle 56 of the dial 32 is inaccessible to the user when the closure 14 is engaged with the container 12. Thus, the dial can only be rotated manually after the closure is removed from the pill container. As a result, the user cannot inadvertently turn the dial 32 in a manner that would result in the wrong indicia 54 being viewed through the window. Consequently, the indicia 54 represents an accurate reminder for the next time a dose is required to be taken.

It should be understood that the embodiment described herein is merely exemplary and that a person skilled in the art may make many variations and modifications without departing from the spirit and scope of the invention. For example, more than one set of indicia 54 may be imprinted on the dial 32 so as to be simultaneously displayed in more than one window of the cap 30 (e.g., a first window showing a day and time indication, and a second window showing a dosage indication). The size and shape of the handle of the dial may be varied (e.g., ball-shaped, pin-shaped), or the handle may be replaced with a sandpaper-like coating applied to the lower surface of the dial. Alternately, the dial may be provided without a handle. The threads 44 of the cap 30 and the threads 24 of the container 12 may be replaced with alternative means for fastening the closure 14 to the container 12 (e.g., clips, clasps, tabs and tab locks, etc.). All such variations and modifications are intended to be included within the scope of the invention as defined in the appended claims.

1. A medication bottle, comprising a container and a closure releasably attached to said container, said closure having a cap and a dial rotatably mounted to said cap, said dial having a first surface and a second surface, said first surface of said dial having a set of indicia for indicating a time period for a user to take a next dosage of medication, said dial having a handle extending outwardly from said second surface thereof for rotating said dial, said handle being positioned within said container when said closure is attached to said container such that said dial is prevented from being inadvertently rotated so as to provide a correct indication of the next dosage time period.

2. A medication bottle as claimed in claim 1, wherein said closure includes a window for displaying said indicia of said dial.

3. A medication bottle as claimed in claim 2, wherein said closure is threadedly attached to said container.

4. A medication bottle as claimed in claim 2, wherein said closure is attached to said container by at least one snap tab.

5. A medication bottle as claimed in claim 3, wherein said indicia includes a day of a week.

6. A medication bottle as claimed in claim 3, wherein said indicia includes a time of day.

7. A medication bottle as claimed in claim 3, wherein said indicia includes a number for indicating a dosage amount.

8. A medication bottle as claimed in claim 3, wherein said container is adapted to receive a plurality of pills.

9. A medication bottle as claimed in claim 3, wherein said container is adapted to receive liquid medication.
